(19) United States
(12) Patent Application Publication
(10) Pub. No.: US 2017/0068923 A1
(43) Pub. Date: Mar. 9, 2017

(54) IDENTIFICATION OF ASSET GROUPS FOR ENSURING CONSISTENT ESTIMATES

(71) Applicant: International Business Machines Corporation, Armonk, NY (US)

(72) Inventors: Sreyash D. Kenkre, Bangalore (IN); Krishnasuri Narayanam, Bangalore (IN); Vinayaka Pandit, Bangalore (IN); Rishi Saket, Bangalore (IN)

(21) Appl. No.: 14/846,103

(22) Filed: Sep. 4, 2015

(51) Int. Cl. G06Q 10/06

(52) U.S. Cl. CPC G06Q 10/063114

(57) ABSTRACT

Methods and arrangements for identifying discrepancies associated with estimates for asset groups. A contemplated method includes: utilizing at least one processor to execute computer code that performs the steps of: receiving a plan comprising at least one activity, wherein the plan comprises a time estimate and a resource estimate for the at least one activity; identifying at least one asset associated with the at least one activity; obtaining data relating to the at least one asset; identifying, using the data obtained, an asset group, wherein an asset group comprises at least two assets having at least one similar datum; detecting at least one discrepancy between at least one of: the time estimate and the resource estimate, for the asset group; and notifying a user of the at least one discrepancy. Other variants and embodiments are broadly contemplated herein.

### BACKGROUND

Large scale maintenance projects require a significant amount of time and resources. The provision of time and resource estimates are generally completed by equipment owners, or people who are most familiar with the equipment. Alternatively, the people who may be involved in estimating the time and resources may be external or hired consultants who may not be the most familiar with the procedures and practices of the company actually completing the maintenance. Generally, the equipment owners, while called equipment owners, are not split by particular pieces of equipment, but rather split by system function and then are assigned all equipment within that system. Such a division results in many different people providing time and resource estimate for a system to a central source, for example, a project planner or scheduler. This information is usually captured within a project plan and used to provide an overall estimate of how long the entire maintenance project will take to complete.

### BRIEF SUMMARY

In summary, one aspect of the inventions provides a method of identifying discrepancies associated with estimates for asset groups, said method comprising: utilizing at least one processor to execute computer code that performs the steps of: receiving a plan comprising at least one activity, wherein the plan comprises a time estimate and a resource estimate for the at least one activity; identifying at least one asset associated with the at least one activity; obtaining data relating to the at least one asset; identifying, using the data obtained, an asset group, wherein an asset group comprises at least two assets having at least one similar datum; detecting at least one discrepancy between at least one of: the time estimate and the resource estimate, for the asset group; and notifying a user of the at least one discrepancy.

Another aspect of the invention provides an apparatus for identifying discrepancies associated with estimates for asset groups, said apparatus comprising: at least one processor; and a computer readable storage medium having computer readable program code embodied therewith and executable by the at least one processor, the computer readable program code comprising: computer readable program code that receives a plan comprising at least one activity, wherein the plan comprises a time estimate and a resource estimate for the at least one activity; computer readable program code that identifies at least one asset associated with the at least one activity; computer readable program code that obtains data relating to the at least one asset; computer readable program code that identifies, using the data obtained, an asset group, wherein an asset group comprises at least two assets having at least one similar datum; computer readable program code that detects at least one discrepancy between at least one of: the time estimate and the resource estimate, for the asset group; and computer readable program code that notifies a user of the at least one discrepancy.

An additional aspect of the invention provides a computer program product for identifying discrepancies associated with estimates for asset groups, comprising: a computer readable storage medium having computer readable program code embodied therewith, the computer readable program code comprising: computer readable program code that receives a plan comprising at least one activity, wherein the plan comprises a time estimate and a resource estimate for the at least one activity; computer readable program code that identifies at least one asset associated with the at least one activity; computer readable program code that obtains data relating to the at least one asset; computer readable program code that identifies, using the data obtained, an asset group, wherein an asset group comprises at least two assets having at least one similar datum; computer readable program code that detects at least one discrepancy between at least one of: the time estimate and the resource estimate, for the asset group; and computer readable program code that notifies a user of the at least one discrepancy.

An additional aspect of the invention provides a method of identifying discrepancies associated with estimates for asset groups, said method comprising: utilizing at least one processor to execute computer code that performs the steps of: receiving a plan comprising at least one activity, wherein the plan comprises a time estimate and a resource estimate for the at least one activity; identifying at least one asset associated with the at least one activity; obtaining data relating to the at least one asset, wherein the data comprises operational history of the asset and characteristics associated with the at least one asset; identifying, using a clustering algorithm on the data obtained, an asset group, wherein an asset group comprises at least two assets having at least one similar datum; detecting at least one discrepancy between at least one of: the time estimate and the resource estimate, for the asset group, wherein the detecting comprises comparing at least one of: the time estimate and the resource estimate, of one asset to at least one of: the time estimate and the resource estimate, of another asset; and notifying a user of the at least one discrepancy and providing the at least one discrepancy to the user.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a system architecture for identification of asset groups for ensuring consistent estimates.

FIG. 2 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

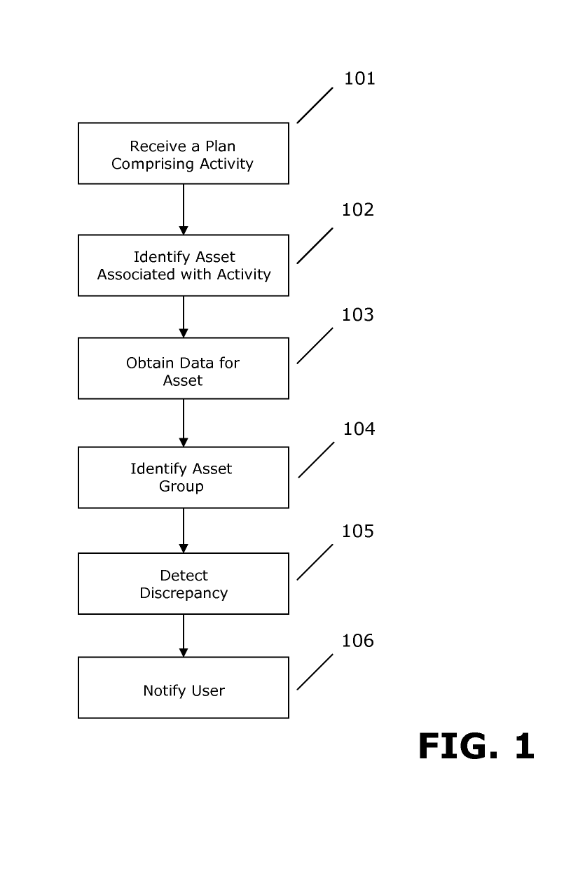

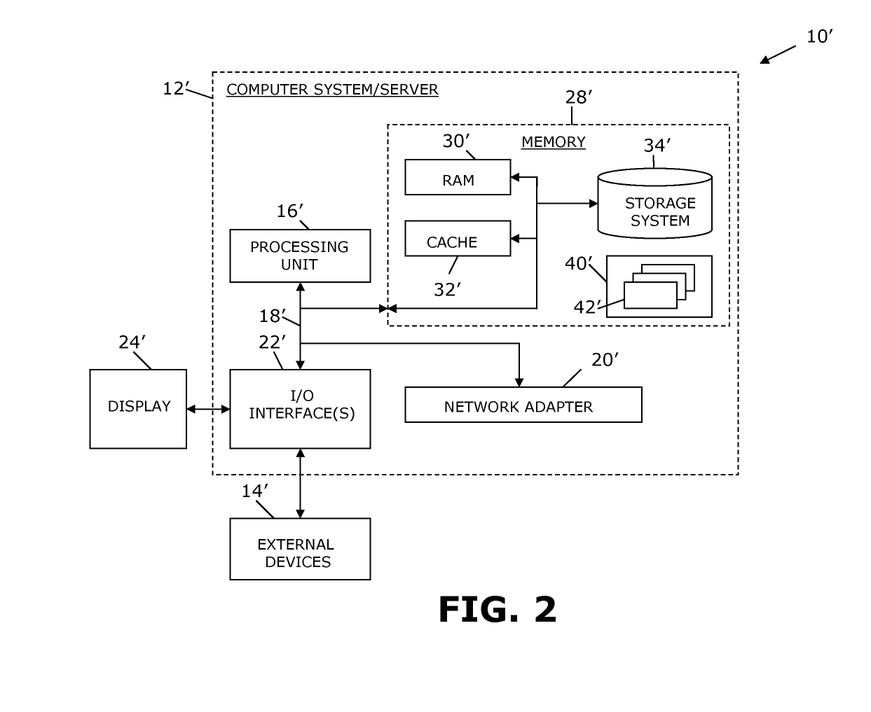

Specific reference will now be made here below to FIG. 1. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 2. In accordance with an example embodiment, most if not all of the process steps, components and outputs discussed with respect to FIG. 1 can be performed or utilized by way of a processing unit or units and system memory such as those indicated, respectively, at 16′ and 28′ in FIG. 2, whether on a server computer, a client computer, a node computer in a distributed network, or any combination thereof.

Before starting a project, particularly a large scale project, a user generally creates a project plan to determine the time, cost, and resources needed for the project. To create these project plans, asset owners are generally asked to provide time and resource estimates because they are generally most familiar with the system and equipment within that system. However, since asset owners are usually split by system rather than asset or equipment pieces, the estimates provided by different equipment owners having the same or similar pieces of equipment within their system may have significant inconsistencies. It is often difficult if not impossible to validate the accuracy of the input provided by the asset owner. Having a solution that can highlight and correct such inconsistencies can make project plans significantly more robust and provide for an overall plan that is more accurate.

One solution to ensure consistency is to perform a manual check of the data, however, this is only feasible if the amount of data is small. Otherwise, a manual check would be time consuming and often inaccurate, if possible at all. Some asset owners may leverage previously completed projects on the system in order to provide a time and resource estimate for the current project. The problem with this approach is that within the time between the previous and current projects, the technology may have advanced in such a way that the previous time and resource used are not useful in the time and resource estimate of the current project.

Without accurate estimates, significant deviations can occur during execution of the project plan. During a large scale project, these deviations can become quite numerous and significantly alter the time estimated to complete the entire project, the cost associated with the project, and the number of resources needed to finish the project. For such large scale projects, such as maintenance projects, the plant or operational facilities are normally shut down and not functioning during the maintenance project. The longer the project takes, the more time and money the company is losing having the plant or operational facility sitting idle.

Current project management software does not have any capability to address the uncertainty associated with time estimates provided as input to the software. In other words, if a time estimate for an activity is provided by a user with an uncertain time duration, the software does not allow such an input. Rather, the time associated with the activity has to be defined, which forces a user to input the activity with a time duration which may be inaccurate. Additionally, such project management software is unaware of the scope of the entire project. In other words, each activity defined within the project management software is not aware of other activities defined within the software and is therefore unable to leverage time and resource estimates used for the same or similar activities or assets.

Condition monitoring and predictive asset maintenance software assists in monitoring equipment. One problem with this type of software is that it focuses only on issues such as failure prediction, anomaly detection while the equipment is in operation, lead time indicators, and wear indicators. Additionally, this type of software primarily focuses on a single piece of equipment and is unable to leverage information from other pieces of equipment which may be similar. Therefore, this type of software fails to focus on operational aspects of maintenance, especially during long maintenance periods.

Some asset management software can provide diagnostic tools that can detect if the asset is performing optimally or requires maintenance. However, the output of this software is not directly fed to software for identifying maintenance time frames. Rather, this information must come from the asset owners. Additionally, this information cannot be used to identify maintenance time frames or resources required for completing the maintenance.

Similarly, original equipment manufacturers (OEMs) may have software that can link condition monitoring to maintenance times. In other words, this software may know that one condition requires a particular amount of maintenance time. However, as with the solutions above, this software works in a vacuum and is “unaware” of other similar equipment. This is because OEMs generally do not have access to measurements of other similar equipment which is manufactured or provided by different vendors. Additionally, this type of software fails to take into account that maintenance execution can be done in various ways (e.g., manual labor vs. automated labor), which creates inaccurate estimates. Further, OEMs tend to not be involved in large scale maintenance projects and like to remain not involved.

Accordingly, broadly contemplated herein, in accordance with at least one embodiment of the invention, are systems and arrangements to identify discrepancies associated with estimates for asset groups. As described in more detail below, in one embodiment the identification of discrepancies comprises identifying inconsistencies between similar asset groups to assist in ensure consistency between the estimates. Additionally as described in more detail below, in one embodiment, the identification of discrepancies comprises identifying consistencies between dissimilar asset groups to assist in identifying assets which have the same or similar estimates but maybe should not.

In one embodiment, a plan comprising at least one activity is received. In addition, a time and/or resource estimate for each activity is provided. An embodiment then identifies an asset within the plan and obtains data, for example, operational history, model number, function, and the like, relating to the asset. Using this data, an embodiment can identify another asset which may have at least one similar datum identify these two pieces of equipment as asset groups. For ease of understanding, the asset groups are described as two assets, however, it should be understood that such asset groups can be identified in any quantity, for example, three or four assets having at least one similar datum. In one embodiment the asset group may be a similar group, which may include two or more assets having substantially similar data. In another embodiment, the asset group may be a dissimilar group, which may include two or more assets having at least one similar datum, but a portion of the data between the two assets is dissimilar.

An embodiment may then identify discrepancies between the time and/or resource estimate provided by the asset owners and notify a user of these discrepancies. In the case of a similar group, the discrepancy may include the time and/or resource estimates between the assets being different. For example, one asset within the similar group may have a time estimate of ten days to perform the same activity which is designated in the time estimate of the other asset as taking five days. The discrepancy, in a dissimilar group, may include the time and/or resource estimates between the assets being the same or similar. For example, the assets within the dissimilar group may have a resource estimate of four technicians. However, the scope of the activity for one of the assets may be larger than the scope of the other asset. Upon identification of the discrepancies, an embodiment may notify the user of the discrepancy.

Referring now to FIG. 1, during the planning stage for a project, an embodiment may receive a plan comprising at least one activity, at 101. An activity may comprise a single step in a process, for example, “check outer case of motor 1234”. Alternatively, the activity may comprise a series of steps, for example the activity may be “maintenance on motor X” and the steps may include “check outer casing on motor X”, “check winding for shorts on motor X”, “check brushes for wear on motor X”, and “replace brushes on motor X”. Receipt of the plan may be through manual entry by a user, uploading of a plan, retrieving a plan from another source, or using some other technique. The plan may be in the form of a project plan, (e.g., using project plan software), simple flowchart, written description of activities, or other format. In other words, the receipt of the plan and the format of the plan does not have to be completed in a specified way for an embodiment to execute the remaining steps as explained in more detail below.

In addition to activities within the plan, the plan may contain time and/or resource estimates for each activity. The plan may additionally contain a description of the scope of the activity to be completed. The scope may include the steps within an activity or may include just a description of the activity to be completed. An example of such a plan may be a maintenance plan for a subsystem of a power generation plant. The maintenance plan may detail the pieces of equipment or asset on which maintenance needs to performed, the type of maintenance to be performed, the time needed to complete the maintenance, and how many and the type of resources required to complete the maintenance in the specified time.

At 102, an embodiment may identify at least one asset associated with the activity within the received plan. Such identification may include a simple identification that an asset is associated with the activity. Alternatively, the identification may include identifying the type of asset (e.g., a pump, sensor, assembly, sub-assembly, or other component or assembly) and may additionally include other identifying distinguishing features of the asset (e.g., serial number, model, manufacturer, location within the plant, etc.).

An embodiment may, at 103, obtain data relating to the at least one asset. In obtaining these data, an embodiment may receive the data or may pull the data from another source. For example, the data may be manually entered by a user or may be pulled from a secondary source or sources containing the necessary data. The data obtained may include any data which may or may not have been obtained or provided at the identification step 102 (e.g., serial number, manufacturer, vendor, location, and other distinguishing characteristics of the asset). In addition, the data may include the function of the asset, for example, what does this asset do with respect to other components. As an example, a pump may be used in a system that transports pure water and the same type of pump may be used in a system which transports impure water. The types of water may assist in defining the function of the pump.

The data may additionally include the load and operational history of the asset. The load information may indicate how much an asset has been actuated (e.g., how many gallons a pump has pumped, how many times a sensor has been actuated, how many rotations a motor has made, etc.). The operational history of the asset may include any maintenance that has been completed on the asset, how long the asset has been in service, has the asset been idle and when, and the like. Other types of data may be obtained if applicable.

Once the data have been obtained, an embodiment may, at 104, identify an asset group. The asset group may comprise two or more assets having at least one similar datum. For example, both assets within the asset group may be of the same type of equipment (e.g., a pump, motor, sensor, etc.), same manufacturer, same function, and the like. The identification of an asset group may rely on a single piece of datum or may require that multiple pieces of equipment be the same or similar. For example, the assets within the asset group may have the same function, manufacturer, operational history, and installation date.

The two assets do not necessarily need to be contained within the plans received at 101 or even within the overall project or execution plan. For example, one embodiment may leverage asset information from a similar project or a previously completed project. On the other hand, the asset groups may be assets which are contained within the plan received at 101 or the overall project plan. For example, a plan may be provided by a system owner having a particular type of fluid pump. Another system within the same plant and undergoing maintenance at the same time may have the same type of fluid pump. This pump may be included in the plan that the second system owner provided. The system may leverage the information in the two plans to identify these two pumps as similar groups.

In one embodiment, the asset group may be identified as a similar group. A similar group may be considered to be assets having substantially similar data. The determination of what is considered substantially similar may differ between projects and equipment. For example, certain project types (e.g., maintenance, replacement, start up, building, etc.) may require assets to have more similarities between data to be considered similar than other projects. As an example, a maintenance project may require that the assets have the same function, operational history, and location to be considered similar, where a building project may require that the assets only have the same function and location to be considered similar. Additionally, depending on the project, in order to make a determination of a group of assets being similar, the scope of the work may need to be the same. For example, if both assets need the same maintenance this scope may help in identifying the asset group as similar.

In identifying whether an asset is similar to another asset, the data obtained do not have be identical between the assets. For example, a difference of serial number or manufacturer may not cause the system to identify the assets as not similar. In one embodiment, a particular piece of datum may be given a different weight than another piece of datum. For example, the operational history of the asset may have a higher weight in identifying similarities than the manufacturer of the asset. The similarity measure may then be dependent on a percentage, statistical calculation, or other measure of similarity, meeting or exceeding a particular threshold, which may be defined by a user or the system. For example, if it is determined that two assets are 80% similar, this may be enough to group them as a similar group.

In one embodiment, the asset group may be identified as a dissimilar group. A dissimilar group may be considered to be assets having at least partially dissimilar data. In other words, dissimilar groups may be assets which have some similar data, but the level of similarity does not reach the level needed to be considered similar. As with the similar group, the determination of a dissimilar group may differ between projects and equipment. Additionally, if the asset group has some data that is dissimilar this may not necessarily mean that the group will be considered to be dissimilar. For example, if the manufacturers for two pumps are different, this data may not necessarily exclude the asset group from being considered a similar group. However, if the assets have almost identical data except that they have different operational histories, they may be considered dissimilar groups based solely on the different operational histories. As another example, if the data are very similar except the scope of the work to be performed is different, the asset group may be considered dissimilar based on the different scopes of work.

One embodiment may use the data obtained at step 103, and use a hierarchical clustering algorithm to identify potential groups of assets. This clustering algorithm may use similar information categories about assets to group the equipment. As an example, if each data entry is identified as a field (e.g., manufacturer, serial number, date of manufacture, etc.), the clustering algorithm may group assets which have the same data within the field (e.g., two assets have the same manufacturer). An embodiment may perform additional clustering using time of last break down or operational history. For example, an embodiment may use multiple passes of the same or different clustering techniques to group and identify asset groups.

Other algorithms may be used for identifying the similarities between assets. For example, if a piece of datum contains numeric data, k-Means, density-based spatial clustering of applications with noise (DBSCAN), ordering points to identify the clustering structure (OPTICS), or another type of clustering algorithm may be used. As another example, if a piece of datum contains categorical data clustering techniques, such as, k-Modes, identification of a similarity measure using Jaccard Distance and then using nearest neighbor algorithms, or other techniques may be used. In the example of series data, example techniques include dynamic time warping, grouping co-integrated time series, conversion to a symbolic representation by defining and distance metric and then using standard clustering algorithms, and other techniques may be used. Other automated techniques that qualitatively identify asset groups may be used. The use of any particular algorithm may be defined by a user or may be dependent on the type of data received at 103. Additionally, multiple algorithms may be used to identify asset groups.

Once asset groups have been identified, an embodiment may at 105, detect discrepancies between the time and/or resource estimates received at 101. The detection at 105 may comprise comparing the time and/or resource estimate associated with one asset to the time and/or resource estimate associated with the other asset in the asset group. Other detection techniques are possible and contemplated, for example, providing the estimates side by side for manual checking, highlighting of differences, and the like.

In the case of an asset group that has been identified as similar, the system may identify these assets as possibly needing similar time and/or resource estimates. In other words, the discrepancy may include detecting that assets contained within a similar group have different time and/or resource estimates. Dissimilar estimates may indicate that the asset owner did not know of a similar asset which should have the same estimates. In the case of an asset group that has been identified as dissimilar, the system may identify these assets as those that should have different time and/or resource estimates. In other words, the discrepancy may include detecting that assets contained within a dissimilar group have the same time and/or resource estimates. Such similar estimates may indicate that an asset owner did not take differences between the assets into account when creating the estimates.

At 106, an embodiment may notify a user of the discrepancies. This notification may be as simple as indicating that at least one discrepancy was found for a particular asset group. One embodiment may additionally provide the at least one discrepancy to the user. For example, the discrepancies may be highlighted, provided in a report or list, circled, enlarged, emailed, or otherwise provided to the user. The presentation of the discrepancies may additionally be in a format which allows for sorting by importance.

The notifying may also comprise prompting and allowing the user to modify one of the time and/or resource estimates for one or both of the assets in the group. The user may also be able to indicate that the discrepancy has been noted but is not going to be modified. In other words, the user may be able to provide an acknowledgement of the notification without the requirement of modification. Other forms of notification and allowing user modification are contemplated and possible.

One embodiment, after receiving and analyzing all the plans in an overall plan (e.g., the maintenance plan for the whole plant), may generate the overall plan. This overall plan may include the received plans which may have additionally been modified to reconcile the discrepancies that were detected and provided to the user.

The system as described in connection with FIG. 1, can additionally be used in a similar manner during an execution phase, for example, while the maintenance is ongoing. In such a scenario, the plan received at 101 may comprise an execution plan. Such a plan may be the overall plan for executing all the projects necessary to complete the large scale project. During the execution of the plan some activities for assets may be completed before activities for assets which may be included in the asset group. For example, one generator in a similar asset group may have its maintenance executed before the other generator in the similar asset group.

Upon completion of the activity for the first asset, the execution plan may be updated to indicate the total completion time (e.g., the actual length of time it took to complete the activity) and the actual resources used (e.g., how many technicians, engineers, planners, etc. it took to complete the activity). The data for the activity may be included for the entire activity (e.g., maintenance of a component) or may be included for each step within an activity (e.g., each step to complete maintenance of a component). As an example, the plant may have four pumps which have been identified as a similar group and the estimated time for completion of the required maintenance is three days with four resources. However, the maintenance for one of the pumps was completed in one day with two resources.

Using these data, the system may detect a discrepancy between the amount of time and/or resources actually used for the first asset, and the amount of time and/or resources estimated to be used for the second asset in the asset group. For example, the maintenance for the pump was completed in one day with two resources as opposed to the estimated time for the remaining pumps as three days with four resources. Additionally, based upon the completion data, an embodiment may now identify an asset group differently. For example, during the execution of the activity associated with the first asset, additional scope may have been added to the activity. Based upon the new data an asset group, including the asset for which the activity was completed, which had been identified as a similar group, may now be considered to be a dissimilar group.

Like with the planning stage as described above, an embodiment may, during the execution stage, notify a user of the discrepancy at 106. The notification of the discrepancy may be in a manner similar to the notification as described above. Additionally, the notification may include modifying the time and/or resource estimate for the asset in the asset group for which the activity has not been completed. For example, during execution of the plan, the system may modify the time and resource estimates for the remaining three pumps to be one day with two resources. This may additionally update the entire duration and resource requirement for the remaining activities within the overall plan.

Referring now to FIG. 3, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the

IN920150182US1 Page 24 of 34 user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of identifying discrepancies associated with estimates for asset groups, said method comprising:
utilizing at least one processor to execute computer code that performs the steps of:
receiving a plan comprising at least one activity, wherein the plan comprises a time estimate and a resource estimate for the at least one activity;
identifying at least one asset associated with the at least one activity;
obtaining data relating to the at least one asset;
identifying, using the data obtained, an asset group, wherein an asset group comprises at least two assets having at least one similar datum;
detecting at least one discrepancy between at least one of: the time estimate and the resource estimate, for the asset group; and
notifying a user of the at least one discrepancy.

2. The method of claim 1, wherein the identified asset group comprises a similar group, wherein a similar group comprises at least two assets having substantially similar data.

3. The method of claim 2, wherein the at least one discrepancy comprises at least one inconsistency between at least one of: the time estimate and the resource estimate, for the similar group.

4. The method of claim 1, wherein the identified asset group comprises a dissimilar group of assets, wherein a dissimilar group comprises at least two assets having data that are at least partially dissimilar.

5. The method of claim 4, wherein the at least one discrepancy comprises at least one consistency between at least one of: the time estimate and the resource estimate, for the dissimilar group.

6. The method of claim 1, wherein the identifying an asset group comprises using a clustering algorithm.

7. The method of claim 1, wherein the data comprise operational history of the at least one asset and characteristics associated with the at least one asset.

8. The method of claim 1, wherein the detecting comprises comparing at least one of: the time estimate and the resource estimate, of one asset to at least one of: the time estimate and the resource estimate, of another asset.

9. The method of claim 1, wherein at least one asset in the asset group comprises an asset not included in the plan received.

10. The method of claim 1, wherein the notifying comprises prompting the user to modify at least one of: the time estimate and the resource estimate, for at least one of the assets of the asset group.

11. The method of claim 1, wherein the plan comprises an execution plan;
wherein the execution plan comprises at least one asset for which at least one activity has been executed and wherein the time estimate comprises a total completion time and wherein the resource estimate comprises actual resources used;
wherein the asset group comprises: the at least one asset and at least one other asset for which a similar activity has not been executed; and
wherein the detecting comprises detecting at least one discrepancy between at least one of: the total completion time and the actual resources used, for the at least one asset, and at least one of: the time estimate and the resource estimate, for the at least one other asset.

12. The method of claim 11, wherein the notifying comprises modifying at least one of: the time estimate and the resource estimate for the at least one other asset based upon the detected discrepancy.

13. An apparatus for identifying discrepancies associated with estimates for asset groups, said apparatus comprising:
at least one processor; and
a computer readable storage medium having computer readable program code embodied therewith and executable by the at least one processor, the computer readable program code comprising:
computer readable program code that receives a plan comprising at least one activity, wherein the plan comprises a time estimate and a resource estimate for the at least one activity;
computer readable program code that identifies at least one asset associated with the at least one activity;
computer readable program code that obtains data relating to the at least one asset;
computer readable program code that identifies, using the data obtained, an asset group, wherein an asset group comprises at least two assets having at least one similar datum;
computer readable program code that detects at least one discrepancy between at least one of: the time estimate and the resource estimate, for the asset group; and
computer readable program code that notifies a user of the at least one discrepancy.

14. A computer program product for identifying discrepancies associated with estimates for asset groups, comprising:
a computer readable storage medium having computer readable program code embodied therewith, the computer readable program code comprising:
computer readable program code that receives a plan comprising at least one activity, wherein the plan comprises a time estimate and a resource estimate for the at least one activity;
computer readable program code that identifies at least one asset associated with the at least one activity;
computer readable program code that obtains data relating to the at least one asset;
computer readable program code that identifies, using the data obtained, an asset group, wherein an asset group comprises at least two assets having at least one similar datum;
computer readable program code that detects at least one discrepancy between at least one of: the time estimate and the resource estimate, for the asset group; and
computer readable program code that notifies a user of the at least one discrepancy.

15. The computer program product of claim 14, wherein the identified asset group comprises a similar group, wherein a similar group comprises at least two assets having substantially similar data and wherein the at least one discrepancy comprises at least one inconsistency between at least one of: the time estimate and the resource estimate, for the similar group.

16. The computer program product of claim 14, wherein the identified asset group comprises a dissimilar group of assets, wherein a dissimilar group comprises at least two assets having data that are at least partially dissimilar and wherein the at least one discrepancy comprises at least one consistency between at least one of: the time estimate and the resource estimate, for the dissimilar group.

17. The computer program product of claim 14, wherein the computer readable program code that identifies an asset group comprises using a clustering algorithm.

18. The computer program product of claim 14, wherein the data comprise operational history of the at least one asset and characteristics associated with the at least one asset.

19. The computer program produce of claim 14, wherein the plan comprises an execution plan;
wherein the execution plan comprises at least one asset for which at least one activity has been executed and wherein the time estimate comprises a total completion time and wherein the resource estimate comprises actual resources used;
wherein the asset group comprises: the at least one asset and at least one other asset for which a similar activity has not been executed; and
wherein the computer readable program code that detects comprises detecting at least one discrepancy between at least one of: the total completion time and the actual resources used, for the at least one asset, and at least one of: the time estimate and the resource estimate, for the at least one other asset.

20. A method of identifying discrepancies associated with estimates for asset groups, said method comprising:
utilizing at least one processor to execute computer code that performs the steps of:
receiving a plan comprising at least one activity, wherein the plan comprises a time estimate and a resource estimate for the at least one activity;
identifying at least one asset associated with the at least one activity;
obtaining data relating to the at least one asset, wherein the data comprise operational history of the asset and characteristics associated with the at least one asset;
identifying, using a clustering algorithm on the data obtained, an asset group, wherein an asset group comprises at least two assets having at least one similar datum;
detecting at least one discrepancy between at least one of: the time estimate and the resource estimate, for the asset group, wherein the detecting comprises comparing at least one of: the time estimate and the resource estimate, of one asset to at least one of:
the time estimate and the resource estimate, of another asset; and
notifying a user of the at least one discrepancy and providing the at least one discrepancy to the user.
